(19) United States
(12) Patent Application Publication
(10) Pub. No.: US 2022/0379513 A1
(43) Pub. Date: Dec. 1, 2022

(54) Mat Clamping Systems And Methods For Mat Cutting Machine

(71) Applicant: Wizard International, Inc., Mukilteo, WA (US)

(72) Inventors: Mike Eugene Bastys, Mill Creek, WA (US); Michael Edward Talcott, Everett, WA (US); David Michael Becker, Shoreline, WA (US); Robert Alan Walters, Mill Creek, WA (US); Stephen Phillip Kerr, Mill Creek, WA (US); James Daniel Carter, Peoria, AZ (US); Trystan Kade MacInnes, Marysville, WA (US)

(73) Assignee: Wizard International, Inc., Mukilteo, WA (US)

(21) Appl. No.: 17/332,887

(22) Filed: May 27, 2021

(51) Int. Cl. B26D 7/02; B26D 5/00

(52) U.S. Cl. CPC B26D 7/02; B26D 5/005

(57) ABSTRACT

A computerized mat cutter machine system includes a mat table having a cutter surface, at least one clamp moveable between a clamped position to secure a matboard to the mat table and a non-clamped position, a cutter head for performing at least one of cutting and finishing a design in the matboard, and a clamp controller bus for communicatively coupling a board controller to a clamp controller of the at least one clamp. The clamp controller bus includes a first bus configured as a dual ended serial differential bus that allows signals to flow from the board controller to the clamp controller, and a second bus configured as an analog bus that allows signals to flow from the clamp controller to the board controller.

### BACKGROUND

Mats are commonly used as borders for framing works of art, such as a photographs, paintings, sketches, and other types of display works. Mats are generally formed by cutting a window or opening into a full-sized sheet or blank stock of mat material. In addition to an opening or window, mats are sometimes decorated with carvings or other decorative finishes.

A computerized mat cutting machine may be used to cut, carve, and/or create decorative features in a standard stock of mat material. In some machines, the mat is secured to the surface of the cutting table with a plurality of clamps extending around the perimeter of the cutting table.

Aspects of the present disclosure are directed to systems and methods for a computerized mat cutting machine that optimize mat clamping, mat cutting, carving, and/or decorating processes.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A computer-implemented method executed using one or more processors associated with a mat cutter machine includes generating a mat design, defining at least one of a cutting and finishing path for the mat design, defining a clamp configuration for at least one clamp that is configured to secure a matboard to a mat table, providing a first status indicator if the at least one clamp should be moved into a clamped position to secure the matboard to the mat table and a second status indicator if the at least one clamp should be moved into a non-clamped position, and activating an actuator assembly to move the at least one clamp between a mat-engaging position and a mat disengaged position.

A computerized mat cutter machine system includes a mat table having a cutter surface, at least one clamp moveable between a clamped position to secure a matboard to the mat table and a non-clamped position, a cutter head for performing at least one of cutting and finishing a design in the matboard, and a clamp controller bus for communicatively coupling a board controller to a clamp controller of the at least one clamp. The clamp controller bus includes a first bus configured as a dual ended serial differential bus that allows signals to flow from the board controller to the clamp controller, and a second bus configured as an analog bus that allows signals to flow from the clamp controller to the board controller.

A computerized mat cutter machine system includes a mat table having a cutter surface, a cutter head for performing at least one of cutting and finishing a design in the matboard, at least one clamp moveable between a clamped position to secure a matboard to the mat table and a non-clamped position. The at least one clamp includes a piston assembly configured to move the at least one clamp between the clamped position and the non-clamped position, a sensor assembly for sensing whether the at least one clamp is in the clamped position or the non-clamped position, and an actuator assembly configured to move the at least one clamp between a mat-engaging position and a mat disengaged position.

A clamp for a computerized mat cutter machine system having a mat table defining a cutter surface includes a piston assembly moveable between an extended position and a retracted position, a clamped portion defined at a first end of the piston assembly, a sensor assembly for sensing whether the piston assembly is in the extended position or the retracted position, and an actuator assembly configured to move the piston assembly between a mat-engaging position, wherein the clamped portion is configured to be moved into a clamped position, and a mat disengaged position, wherein the clamped portion is configured to be moved into a non-clamped position.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an isometric view of an exemplary computerized mat cutting machine (CMC) having a plurality of clamp assemblies extending around a perimeter of a cutting table.

FIG. 2 shows an isometric view of a first exemplary embodiment of a clamp assembly for use with the exemplary CMC of FIG. 1.

FIG. 3 shows an isometric cross-sectional view of the clamp assembly of FIG. 2, taken substantially across line 3-3, wherein the clamp assembly is shown in a first position.

FIG. 4 shows an isometric cross-sectional view of the clamp assembly of FIG. 3, wherein the clamp assembly is shown in a second position.

FIG. 5 shows an isometric view of a second exemplary embodiment of a clamp assembly for use with the exemplary CMC of FIG. 1, wherein the clamp assembly is shown in a first position.

FIG. 6 shows an isometric view of the clamp assembly of FIG. 6, wherein the clamp assembly is shown in a second position.

FIG. 7 shows an isometric cross-sectional view of the clamp assembly of FIG. 6, taken substantially across line 8-8.

FIG. 8 shows an isometric view of the clamp assembly of FIG. 7, wherein the clamp assembly is shown in a third position.

FIG. 9 shows an isometric cross-sectional view of the clamp assembly of FIG. 8, wherein the clamp assembly is shown in a fourth position.

FIG. 10 is a block diagram of an environment in which the present systems and methods may be implemented.

FIG. 11 is a block diagram of exemplary system architecture for use with CMC systems and methods described herein.

FIG. 12 is a swim diagram illustrating the various ways components of a CMC system can interact.

FIG. 13 is a screen shot of an exemplary GUI display used to provide information about a CMC.

FIG. 14 shows a graphical depiction of an exemplary bus structure of a CMC system.

FIG. 15 is a flowchart illustrating a method for addressing clamps of a CMC.

FIG. 16 is a block diagram illustrating an example of a computing device.

### DETAILED DESCRIPTION

The present disclosure provides systems and methods for using a computerized mat cutting machine that optimize mat clamping, mat cutting, carving, and/or decorating processes. Although the systems and methods are shown and described herein with a computerized mat cutting machine, it should be appreciated that the systems and methods described herein may be used with any suitable machine.

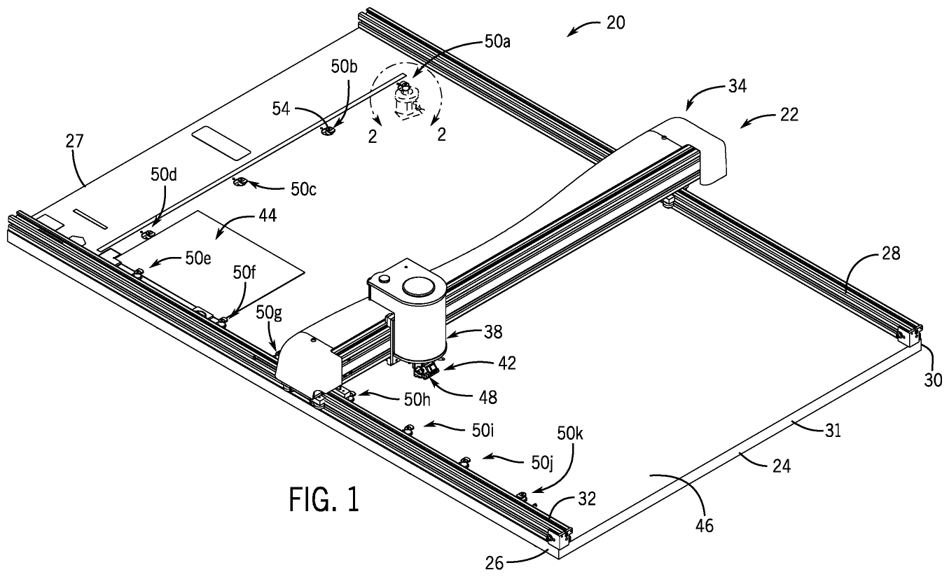

FIG. 1 shows an exemplary embodiment of a computerized mat cutting machine (CMC) 20 for cutting or carving openings, windows, and/or creating decorative features (such as inscribing with a pen, debossing, vinyl cutting, and box making, hereinafter sometimes simply referred to as “cutting” and/or “finishing” or the like for simplicity) in a matboard 44. The CMC 20 includes a mat table 24 having a cutting surface 46 on which the matboard 44 may be cut or finished. The mat table 24 further includes first and second elongated edges 26 and 30 transverse to first and second shortened edges 27 and 31. First and second rails 28 and 32 extending along the first and second elongated edges 26 and 30 of the mat table 24 slidingly receive first and second ends of a longitudinal drive assembly 34, such as a gantry.

The longitudinal drive assembly 34 sliding receives a transverse drive assembly 38. The transverse drive assembly 38 houses at least one motor (not shown) that moves the transverse drive assembly 38 along an axis of the longitudinal drive assembly 34. An orthogonal drive assembly 42 moves (i.e., translates) a connected cutting blade or other decorating tool (e.g., a pen) transverse to the axis of the longitudinal drive assembly 34. The longitudinal drive assembly 34, transverse drive assembly 38, and orthogonal drive assembly 42 form a combined positioning system 22 for cutting a desired opening or decorative carving in a matboard 44 or otherwise applying a decorative finish to the matboard. More specifically, a connected cutting blade or other decorating tool can be moved in and x-, y-, and z-direction to make the desired cuts or finishes on the matboard 44 when positioned on the mat table 24.

In one embodiment, a rotational drive assembly 48 is also included in the combined positioning system 22 to rotate the connected cutting blade or other decorating tool about an axis orthogonal to the axis of the longitudinal drive assembly 34 and vary the alignment of the blade or tool. In that regard, when a blade is being used, the combined positioning system 22 allows the cutting blade to be cuttingly inserted into the matboard 44 and thereafter moved in any desired direction to cut a precise opening or decorative carving of any shape (with straight or beveled edges) into the matboard. The rotational drive assembly 48 together with the transverse drive assembly 38 and the orthogonal drive assembly 42 may hereinafter simply be referred to as a “cutter head.”

To ensure precise cutting, carving, and finishing, the matboard 44 is secured against the mat table 24 with a plurality of clamps 50a-50k (hereinafter sometimes simply referred to as “clamps 50” or a “clamp 50” for simplicity). The clamps 50 are positioned around at least a portion of the perimeter of the mat table 24, such as along the first bottom elongated edge 26 and the first shortened edge 27 of the mat table 24.

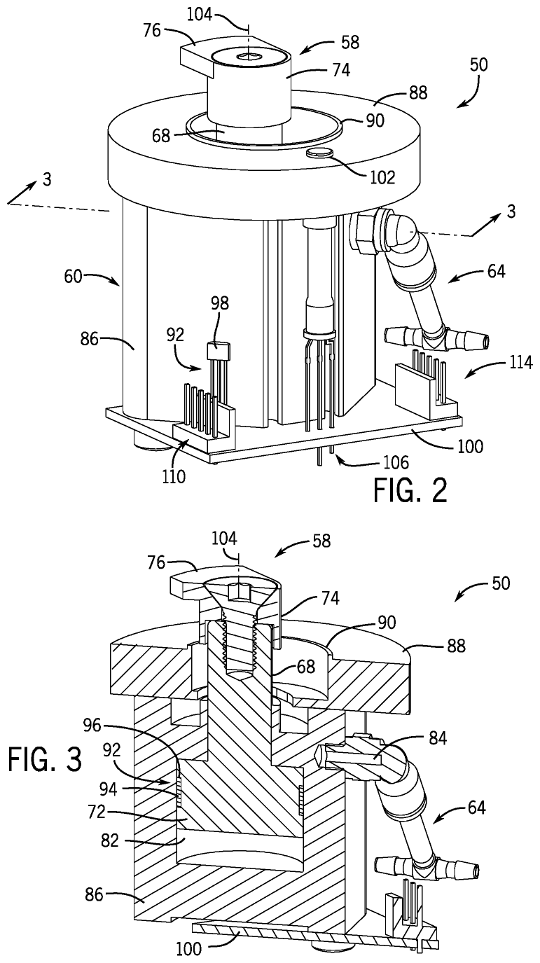

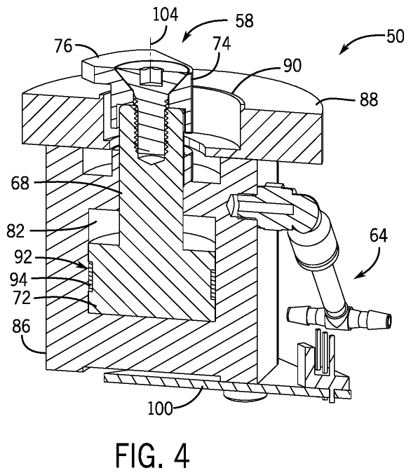

The clamps 50 are generally configured to move between an extended position, wherein the clamp is spaced from the mat table 24 and matboard 44 (see FIGS. 2 and 3), a first retracted position, wherein the clamp presses down against the mat table 24 and matboard 44 to secure the matboard 44 to the mat table 24 (see FIG. 4), and a second retracted position, wherein the clamp recesses beneath the cutting surface 46.

In the extended position, the clamp 50 can be pivoted about its longitudinal axis between a mat engaging position and a mat disengaged position. In the extended, mat engaging position, the clamp can be retracted into the first retracted position to press down against the matboard 44 (see button clamps 50b-50j in FIG. 1). In the extended, mat disengaged position, the clamp can be retracted into the second retracted position to recess beneath the cutting surface 46 within an opening 54 in the mat table 24 (see button clamps 50a and 50k in FIG. 1).

In the mat disengaged, second retracted position, the clamp 50 does not interfere with features of the CMC 20. For instance, in some situations, the orthogonal drive assembly 42 or cutting head may need to pass over the clamp to enter or leave the cutting or finishing area of the matboard 44. If the clamp 50 was extended relative to the mat table surface, the cutting head would hit the clamp when entering or leaving the cutting or finishing area of the matboard 44, thereby damaging the cutter head. In the disengaged, second retracted position, the clamp 50 does not obstruct the cutting or finishing path of the cutter head.

Exemplary CMC systems and methods described herein are generally configured to determine if the clamp 50 is in the extended position, the first or second retracted position, the mat engaging position, and/or the disengaged position, to communicate the position of the clamp 50, and to move the clamp 50 between the extended position, the first or second retracted position, the mat engaging position, and/or the disengaged position. These and additional aspects of the CMC systems and methods will become better understood by the description that follows.

### Exemplary Embodiments of a Clamp

Exemplary embodiments of clamps suitable for use with the CMC 20 or another suitable machine will first be described.

FIGS. 2-4 depict a first exemplary embodiment of a clamp 50 for use with the CMC 20 or any other suitable machine. FIG. 2 particularly depicts clamp 50a shown in FIG. 1 (specifically, clamp 50A is shown partially protruding through opening 54 in the mat table 24); however, for simplicity, reference number 50 will be hereinafter used in describing the clamp shown in FIGS. 2-4.

Clamp 50 is generally configured as a button clamp having a piston assembly 58 movable between an extended position and first and second retracted positions within a cylinder assembly 60, wherein the extended position and first and second retracted positions of the piston assembly 58 correspond to the extended position and first and second retracted positions of the clamp 50. As may best be seen by referring to FIGS. 3 and 4, the piston assembly 58 includes an elongated cylindrical rod 68 having a piston 72 defined at its lower end and a head 74 defined on or otherwise secured to its upper end. A clamping portion 76 extends transversely from the head 74 and is engageble with a piece of matboard 44 as the piston is moved into the first retracted position within the cylinder assembly 60 when the clamp 50 is in the mat engaging position.

The piston 72 is moveable axially between the extended and first and second retracted positions within a cylinder base 86 of the cylinder assembly 60 to correspondingly move the head 74 and clamping portion 76 between the extended and first and second retracted positions. Although the piston 72 may be moved axially within the cylinder base 86 in any suitable manner, in the depicted exemplary embodiment, the piston 72 is moveable axially through pressurized air originating from a pressurized air source of a pneumatic assembly 64. In particular, the piston 72 is moveably received within a pressurizable chamber 82 defined within an interior of the cylinder base 86. Pressurized air passes through an inlet 84 into the chamber 82 to move the piston 72 between extended and retracted positions within the cylinder base 86.

In one embodiment, the clamp 50 includes a biasing assembly (not shown), such as a compression spring, that biases the piston 72 into the extended position. In such an embodiment, the pressurized air moves the piston 72 into the first or second retracted position within the cylinder base 86, and the biasing assembly biases the piston 72 back into the extended position when the air pressure is released. A detent mechanism or similar may be used to help secure the piston 72 in the first or second retracted position in addition to or in lieu of using pressurized air. It should be appreciated that the piston 72 may be moveable axially within the cylinder base 86 in any other suitable manner, such as through hydraulics, electromechanical assemblies, or other assemblies.

The upper end of the cylinder base 86 is enclosed with a cylinder cap 88 having an opening 90 defined substantially centrally therein through which the piston rod 68 and head 74 protrude. The cylinder cap 88 may be configured to be secured to an underside surface of the mat table 24 such that the piston assembly 58 may move through the opening 54 in the mat table 24 between the extended and first and second retracted positions.

The clamp 50 includes a sensor assembly 92 configured to determine the position of the clamp 50. For instance, the sensor assembly 92 may be configured to detect and communicate the position of the piston assembly 58, such as whether the piston 72 is in the extended or first or second retracted position within the pressurizeable chamber 82.

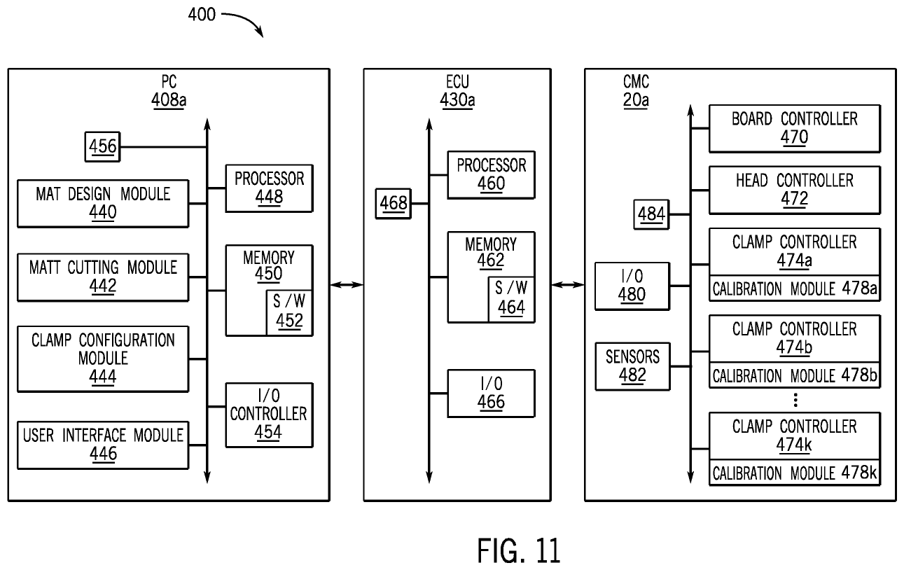

In the depicted exemplary embodiment, the sensor assembly 92 includes a first sensor element 94 secured to the piston 72 that is detectable by a second sensor element 98 disposed within or near the cylinder base 86. When the piston 72 is moved into a retracted or extended position, the first sensor element 94 may be sensed by the second sensor element 98 or vice versa. For instance, when the piston 72 is moved into the first or second retracted position (i.e., at or near the bottom of the pressurizeable chamber 82), the first sensor element 94 is sensed by the second sensor element 98. The second sensor element 98, upon sensing the first sensor element 94, outputs a signal to a controller (see FIG. 11) indicative that the piston 72 is in the first or second retracted position.

In one exemplary embodiment, the sensor assembly 92 is a magnetic sensor assembly. For instance, the first sensor element 94 may be a ring magnet, and the second sensor element 98 may be a sensor that detects the magnitude of magnetism generated by the ring magnet. Of course, the first sensor element 94 need not be a ring magnet, it may instead be in another form, such as a button magnet secured within the side of the piston 72. Further, the second sensor element 98 may instead be configured as a magnet and the annular first sensor element 94 may be configured as a sensor configured to detect the magnet when the piston 72 is moved into a retracted or extended position. Moreover, it should be appreciated that other sensor assemblies may also be used, such as a reed switch an inductive coil, etc.

The second sensor element 98 is electronically coupled to a printed circuit board (PCB) 100, which has at least one clamp controller (described in further detail below). The clamp controller is configured to process incoming instructions for controlling the clamp 50 and output signals indicative of the clamp position.

The PCB 100 also includes first and second connector assemblies 110 and 114 configured to place the PCB 100 into communicative connection with other PCBs or components of the CMC 20. Fewer or more than two connector assemblies may instead be used to accommodate the necessary communications between components. The PCB 100 may also include any other electronic components for executing instructions sent to the clamp controller.

An LED assembly 106 may also be electronically coupled to the PCB 100 that is configured to visually indicate an aspect about the clamp 50 through an LED arrangement. The LED assembly 106 includes at least one LED 102 located within the cylinder cap 88 that is positioned to emit light within a corresponding opening in the mat table 24. The LED 102 may emit light to indicate when a certain event occurs. The LED 102 may emit a flashing light, a specific color light, or any other light to indicate one or more events of the clamp 50 or the CMC 20. For instance, the LED 102 may emit a red light to indicate that the clamp 50 is in the mat engaging, first retracted (clamped) position when it actually needs to be in the mat disengaged, second retracted (non-clamped or recessed) position.

If the clamp needs to be moved from the mat engaging position to the mat disengaged position (or vice versa), the clamp 250 is rotated clockwise or counterclockwise about one hundred eighty degrees (180°) around a piston assembly axis 104. More particularly, a user can grasp the clamping portion 76 and/or the elongated cylindrical rod 68 of the piston 72 and manually turn the piston assembly 58 about its axis 104 into the mat engaging position or the mat disengaged position.

Operation of the clamp 50 will now be described. Referring to FIGS. 2 and 3, the clamp 50 is shown in a mat engaging, extended position. More specifically, the piston 72 is biased into the extended position with a biasing member and/or through pressurized air. Moreover, the clamping portion 76 of the clamp 50 extends toward the middle of the mat table 24 such that it can engage and clamp down onto a mat when retracted. In that regard, pressurized air can be used to move the clamp 50 into the mat engaging, first retracted (clamped) position, as shown in FIG. 4.

In the alternative, the clamp 50 can be rotated about the piston assembly axis 104 into a mat disengaged position. Once in the mat disengaged position, the clamp 50 can be retracted (through the piston 72) into the second retracted (recessed) position within the opening 54 in the mat table 24 (see button clamps 50a and 50k in FIG. 1). In the recessed position below the cutting surface 46 of the mat table 24, the clamp 50 will not occlude the cutter head.

The LED 102 can be used to indicate whether the clamp 50 is in at least one of the mat engaging position, the mat disengaged position, the extended position, and/or the first or second retracted position. In this manner, the operator can receive information about the status and position of the clamp 50 and adjust its position and/or the cutting/finishing technique as needed.

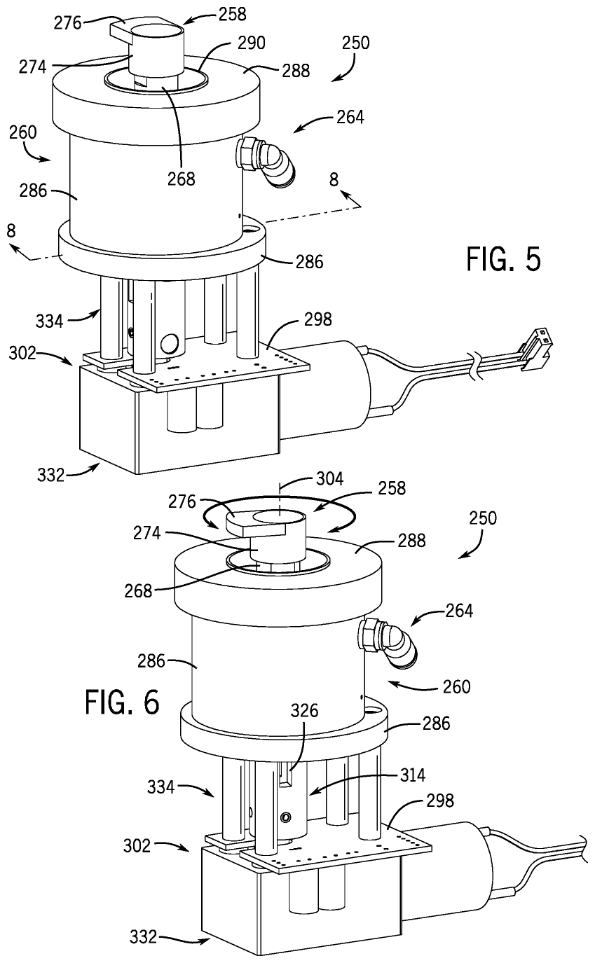

FIGS. 5-8 depict a second exemplary embodiment of a clamp 250 for use with the CMC 20 or another suitable machine. Clamp 250 is also generally configured as a button clamp having elements that are similar to the elements of clamp 50 described above. Therefore, for ease of reference, the same reference numerals are used for similar elements except in the '200 series.

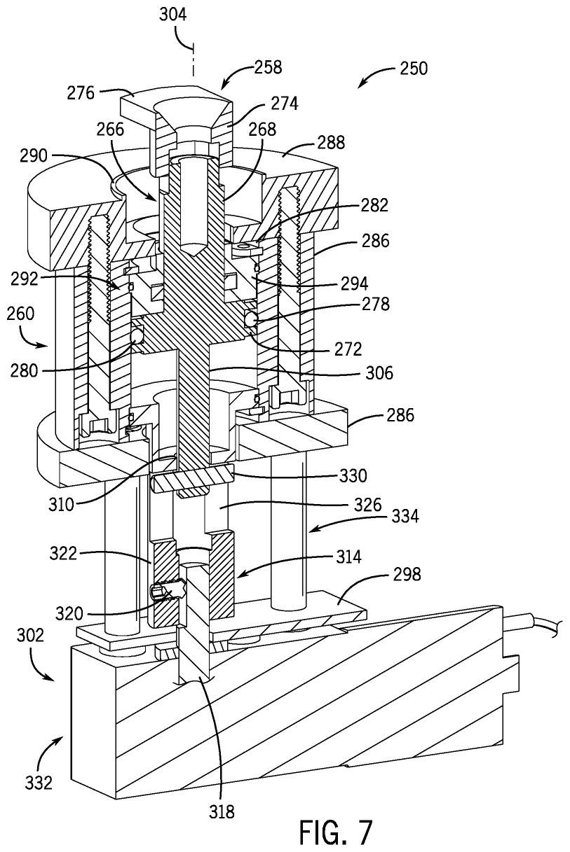

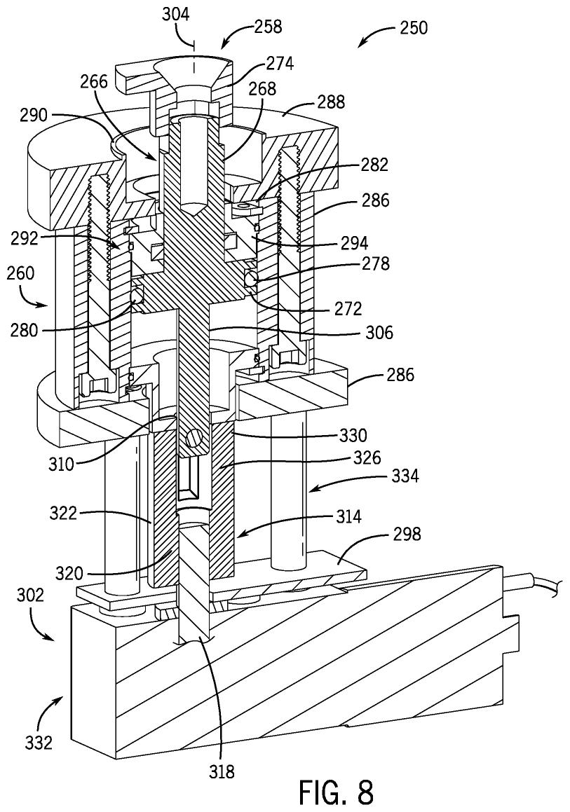

Clamp 250 has a piston assembly 258 movable between extended and first and second retracted positions within a cylinder assembly 260. As may best be seen by referring to FIGS. 7 and 8, the piston assembly 258 includes an elongated cylindrical rod 266 having an upper rod portion 268 with a piston 272 defined at its lower end and a head 274 defined on or otherwise secured to its upper end. A clamping portion 276 extends transversely from the head 274 and is engageble with a piece of matboard 44 on the cutting surface 46 as the piston is moved into a first lowered position within the cylinder assembly 260 when the clamp 250 is in the mat engaging position.

The piston 272 is moveable axially between extended and first and second retracted positions within a cylinder base 286 of the cylinder assembly 260 to correspondingly move the head 274 and clamping portion 276 between the extended and first and second retracted positions. Although the piston 272 may be moved axially within the cylinder base 286 in any suitable manner, in the depicted exemplary embodiment, the piston 272 is moveable axially through pressurized air originating from a pressurized air source of a pneumatic assembly 264.

In one embodiment, the clamp 250 includes a biasing assembly (not shown), such as a compression spring that biases the piston 272 into the extended position. In such an embodiment, the pressurized air moves the piston 272 into the retracted positions within the cylinder base 286, and the biasing assembly biases the piston 272 back into the extended position when the air pressure is released. A detent mechanism or similar may be used to help secure the piston 272 in the retracted positions in addition to or in lieu of using pressurized air. It should be appreciated that the piston 272 may be moveable axially within the cylinder base 286 in any other suitable manner, such as through hydraulics, electromechanical assemblies, or other assemblies.

The upper end of the cylinder base 286 is enclosed with a cylinder cap 288 having an opening 290 defined substantially centrally therein through which the piston rod 268 and head 274 protrude. The cylinder cap 288 may be configured to be secured to and underside surface of the mat table 24 such that the piston assembly 258 may move through the opening 54 in the mat table 24 between the extended and first and second retracted positions.

The clamp 250 includes a sensor assembly 292 configured to determine whether the position of the clamp 250 is in the extended or retracted positions. The sensor assembly 292 may be any suitable assembly configured to detect and communicate the position of the piston assembly 258, such as whether the piston 272 is in the extended or the first or second retracted position within the pressurizeable chamber 282.

In the depicted exemplary embodiment, the sensor assembly 292 is shown including a first sensor element 294 located above the piston 272 that is detectable by a second sensor element (not shown) disposed within or near the cylinder base 286. When the piston 272 is moved into the extended or the first or second retracted position, the first sensor element 294 may be sensed by the second sensor element or vice versa. For instance, when the piston 272 is moved into the first or second retracted position (i.e., at or near the bottom of the pressurizeable chamber 282), the first sensor element 294 is sensed by the second sensor element 298. The second sensor element, upon sensing the first sensor element 294, outputs a signal to a controller (see FIG. 11) indicative that the piston 272 is in the first or second retracted position.

In this exemplary embodiment, the sensor assembly 292 may be a magnetic sensor assembly. For instance, the first sensor element 294 may be a ring magnet, and the second sensor element may be a sensor that detects the magnitude of magnetism generated by the ring magnet. Of course, the annular first sensor element 294 need not be a ring magnet, it may instead be in another form, such as a button magnet secured within the side of the piston 272. Further, the second sensor element may instead be configured as a magnet and the annular first sensor element 294 may be configured as a sensor configured to detect the magnet when the piston 272 is moved into the extended or the first or second retracted position. Moreover, it should be appreciated that other sensor assemblies may also be used such as a reed switch an inductive coil, etc.

The second sensor element(s) is electronically coupled to a printed circuit board (PCB) 298, which has a clamp controller (described in further detail below). The clamp controller is configured to process incoming instructions for controlling the clamp. The clamp controller is also configured to output signals indicative of the clamp position.

An LED assembly (not shown) may also be electronically coupled to the PCB 298 that is configured to visual indicate an aspect about the clamp 250 through an LED arrangement. The LED assembly may include at least one LED located within the cylinder cap 288 that is positioned to emit light within a corresponding opening in the mat table 24. The LED may emit light to indicate when a certain event occurs. For instance, the LED may emit a red light to indicate that the clamp 250 is in the mat engaging, first retracted (clamped) position when it actually needs to be in the mat disengaged second retracted (recessed) position. The LED may instead emit a flashing light, a different color light, or any other light to indicate one or more events of the clamp 250 or the CMC 20.

The clamp 250 further includes an actuator assembly 302 configured to rotate the clamp 250 about a piston assembly axis 304 between the mat engaging position (see FIG. 7), wherein the clamp 250 can be pressed down against the matboard 44 in the first retracted position (see button clamps 50b-50j in FIG. 1), and a mat disengaged position (see FIG. 8), wherein the clamp 250 can be recessed within the opening 54 in the mat table 24 in the second retracted position (see button clamps 50a and 50k in FIG. 1).

The actuator assembly 302 interfaces with the piston assembly 258 of the clamp 250 through a lower rod portion 306 of the rod 266, which extends axially from the upper rod portion 268. The piston 272 divides the rod 266 between the upper rod portion 268 and the lower rod portion 306. In that regard, an annular seal 278, such as an O-ring, is disposed within a corresponding annular groove 280 of the piston 272 to seal off the pressurizeable chamber 282 beneath the piston 272.

The lower end of the lower rod portion 306 is coupled to a drive shaft 318 of the actuator assembly 302 such that rotation of the drive shaft 318 causes corresponding rotation of the lower rod portion 306. At the same time, the lower rod portion 306 can move vertically relative to the drive shaft 318 to accommodate movement of the clamp 250 between the extended and retracted positions.

The lower rod portion 306 is slidably secured to the drive shaft 318 through an motor coupler 314. Any suitable motor coupler 314 may be used to couple the lower rod portion 306 to the drive shaft 318 while allowing the lower rod portion 306 to move vertically relative to the drive shaft 318. In the depicted exemplary embodiment, the motor coupler 314 is generally cylindrical in shape and includes an upper flanged portion 316 sealingly disposed in an opening in the cylinder base 286 and a cylindrical body portion 322 extending downwardly from the upper flanged portion 316.

At its lower end, the cylindrical body portion 322 is coaxially secured to the distal end of the drive shaft 318, such as through a fastener assembly 320 (e.g., a set screw) or another suitable assembly. At its upper end, the cylindrical body portion 322 includes an axial slot 326 configured to slidably receive a transverse sliding member 330 extending transversely through the distal end of the lower rod portion 306. The transverse sliding member 330 translates along the axial path of the axial slot 326 when the lower rod portion 306 moves up and down with the piston assembly 258. At the same time, the transverse sliding member 330 transmits torque from the drive shaft 318 (through the motor coupler 314) to the lower rod portion 306 to move the piston assembly 258, and therefore the clamp 250, between the mat engaging position and the mat disengaged position.

The actuator assembly 302 may include any drive mechanism suitable for rotating the drive shaft 318, and therefore the clamp 250, between the mat engaging position and the mat disengaged position. For instance, the actuator assembly 302 may include an electric motor 332 (represented in block form only) configured to rotate the drive shaft 318. Any suitable electric motor (stepper, servo, brushless, etc.) may be used. The clamp 50 may also include a plurality of stand-offs 334 extending between the cylinder base 286 and the motor 332 to help support the piston and cylinder assemblies 258 and 260 above the motor 332 and to allow the cylindrical body portion 322 to rotate relative to the cylinder base 286 and PCB 298.

The sensor assembly 292 described above may further be configured to sense the position of the clamp 250 as it is moved between the mat engaging position and the mat disengaged position. In that regard, the sensor assembly 292 may include one or more sensors (not shown) that are configured to sense the position or motion of the output shaft 318 (or rotor) of the motor 332. Any suitable sensors may be used, such as magnetic assemblies, resolvers, optical or capacitive encoders, Hall-effect devices, etc.

For instance, a disk or button type magnet attached to the motor coupler 314 may be detected by a first sensor located on the PCB 298 when the motor coupler 314 is in the mat engaging position, and the magnet may be detected by a second sensor located on the PCB 298 (one hundred eighty degrees (180°) from the first sensor) when the motor coupler 314 is in the mat disengaged position. The first and second sensors may also or instead be used to detect whether the position of the clamp 250 is in the extended or retracted position. For instance, the first and second sensors may only detect the magnet when the piston 272 is in the extended or retracted position.

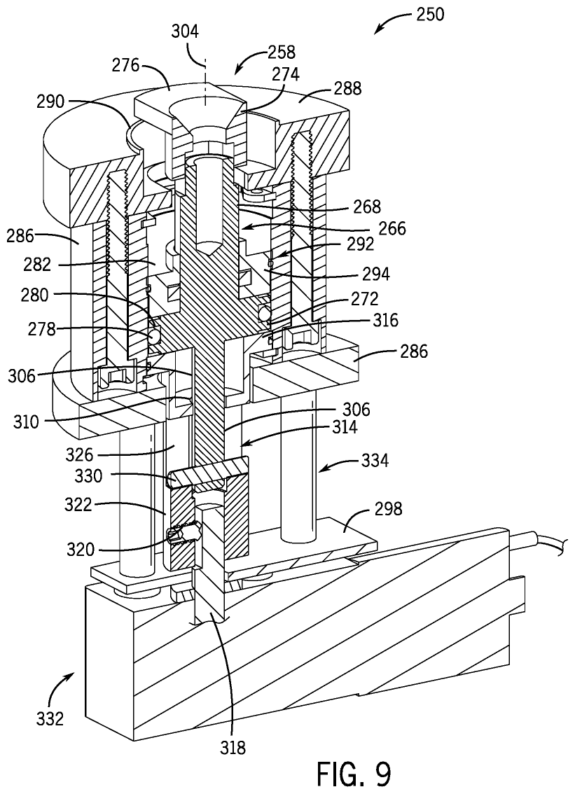

Operation of the clamp 250 will now be described. Referring to FIGS. 5 and 7, the clamp 250 is shown in a mat engaging, extended position. More specifically, the piston 272 is biased into the extended position with a biasing member and/or through pressurized air. Moreover, the clamping portion 276 of the clamp 250 extends toward the middle of the mat table 24 such that it can engage and clamp down onto a mat when retracted. In that regard, pressurized air can be used to move the clamp 250 into the mat engaging, first retracted (clamped) position (see FIG. 9). As the piston 272 is retracted, the transverse sliding member 330 slides within the axial slot of the motor coupler 314.

In the alternative, the clamp 250 can be rotated about the piston assembly axis 304 into the mat disengaged position. To rotate the clamp 250 into a mat disengaged position, the motor 332 of the actuator assembly 302 is activated to rotate the drive shaft 318 clockwise or counterclockwise about one hundred eighty degrees (180°). Once in the mat disengaged position, the clamp 250 can be retracted (through the piston 272) into the second lowered (recessed) position within the opening 54 in the mat table 24 (see button clamps 50a and 50k in FIG. 1). In the recessed position below the cutting surface 46 of the mat table 24, the clamp 250 will not occlude the cutter head.

The LED can be used to indicate whether the clamp 250 is in at least one of the mat engaging position, the mat disengaged position, the extended position, and/or the first or second retracted position. In this manner, the operator can receive information about the status and position of the clamp 250 and adjust its position and/or the cutting/finishing technique as needed.

### CMC System Hardware and Software Applications

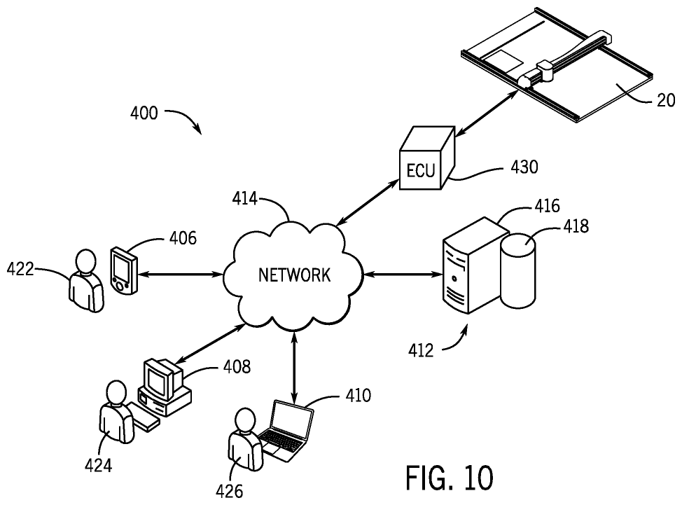

Referring to FIG. 10, the CMC 20 is shown in communication with one or more computing devices for smart device control and interactive software applications. When connected, a user may use a software application on a computing device(s) to configure or direct the operation of CMC 20, for example by manually configuring a variety of operation settings to achieve a customized mat cutting or finishing, or by interacting with a software application that automatically directs the operation of CMC 20 without exposing the particular details of operation to a user. Communication may be bi-directional, with a computing device directing the operation of CMC 20 and with CMC 20 providing input to a computing device based at least in part on a user's activity or interaction.

FIG. 10 depicts an example CMC system 400 that can be used in implementations of the present disclosure. The example system 400 includes the CMC 20, a plurality of client computing devices 406, 408, and 410 each associated with a user 422, 424, and 426, and a computing system 412. The computing system 412 can include one or more computing devices 416 (e.g., one or more servers) and one or more computer-readable storage devices 418 (e.g., one or more databases). The computing devices 406, 408, and 410 and the computing system 412 can communicate with each other through a network 414. The computing devices 406, 408, and 410 and the computing system 412 can communicate with the CMC 20 via a control unit (ECU) 430.

Each of the computing devices 406, 408, 410, and 416 and the ECU 430 can represent various forms of processing devices. Example processing devices can include a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. The computing devices 406, 408, 410 and 416 and the ECU 430 can be provided access to and/or receive application software executed and/or stored on any of the other computing devices 406, 408, 410 and 416 and the ECU 430. The computing device 416 can represent various forms of servers including, but not limited to a web server, an application server, a proxy server, a network server, or a server farm. In some examples, the computing device 416 performs functions of a social network server.

In some implementations, the system 400 can be a distributed client/server system that spans one or more networks such as the network 414. The network 414 can be a large computer network, such as a local area network (LAN), wide area network (WAN), the Internet, a cellular network, or a combination thereof connecting any number of mobile clients, fixed clients, and servers. In some implementations, each client (e.g., computing devices 406, 408, and 410) can communicate with servers (e.g., computing device 416) via a virtual private network (VPN), Secure Shell (SSH) tunnel, or other secure network connection. In some implementations, the network 414 can further include a corporate network (e.g., intranet) and one or more wireless access points.

It should be appreciated that in some implementations, certain components of the system 400 are eliminated; and therefore, the components may be directly coupled via a wired connection, such as a USB connection. For instance, in an exemplary embodiment, the system 400 merely includes computing device 408, ECU 430, and CMC 20.

FIG. 11 is an exemplary block diagram of a CMC system 400a having a computing device or PC 408a, an ECU 430a, and a CMC 20a, which may be examples of the computing device 408, ECU 430, and CMC 20 referenced above with respect to FIG. 1 or 10. In that regard, identical reference numerals are used except in the “a” series. Moreover, the CMC system 400a may also include some or all of the other components shown in FIG. 10.

The PC 408a is generally configured to allow a user to interface with the CMC 20a to control the cutting/finishing process of the CMC 20a. The ECU 430a is generally configured to receive, process, and send data between the PC 408a and the CMC 20a. The CMC 20a, as described above with respect to FIG. 1, is generally configured to apply a desired cut or finish to a piece of matboard 44. It should be appreciated that some or all of the functionality of the ECU 430a may instead be incorporated into the PC 408a and/or the CMC 20a. Moreover, some or all of the functionality of the PC 408a may instead be incorporated into the ECU 430a and/or the CMC 20a.

The PC 408a, which is generally configured to allow a user to interface with the CMC 20a to control the cutting/finishing process of the CMC 20a, may include a mat design module 440, a mat cutting module 442, a clamp configuration module 444, and a user interface module 446. The PC 408a may further include a processor 448 and memory 450 (including software/firmware code (SW) 452) and an input/output (I/O) controller 454. All of the components of the PC 408a may communicate, directly or indirectly, with one another via one or more buses 456.

The user interface module 446 of the PC 408a may enable a person to interact with the PC 408a when using the mat design module 440, mat cutting module 442, and the clamp configuration module 444. For example, the user interface module 245 may include a visual display such as a display screen, an audio device such as a speaker, and various input devices such as a keyboard, touch-screen, microphone, or the like. Multimodal inputs and outputs may be provided as well. In some embodiments, the user interface module 446 may communicate with a remote or external device through the I/O controller 454. The operating system provided on input/output controller 454 may be iOS®, ANDROID®, MS-DOS®, MS-WINDOWS®, OS/2®, UNIX®, LINUX®, or another known operating system.

The ECU 430a, which is generally configured to receive, process, and send data between the PC 408a and the CMC 20a. In that regard, any description provided herein of a signal(s) being sent from the PC 408a to the CMC 20a may first be processed and repackaged by the ECU 430a. The ECU 430a may include a processor 460, memory 462 (including software/firmware code (SW) 464), and an input/output (I/O) 466 (optionally with a controller) for communicating with the PC 408a and the ECU 430a. All of the components of the ECU 430a may communicate, directly or indirectly, with one another via one or more buses 468.

The CMC 20a may be an example of the CMC 20 discussed with relation to FIG. 1. In that regard, reference may be made to the components of the CMC 20 shown in FIG. 1 in describing the CMC 20a. The CMC 20a may include a board controller 470 for controlling the communications between the ECU 430a and other controllers of the CMC 20a, a head controller 472 for controlling the combined positioning system 22 and/or the cutter head of the CMC 20a, and a clamp controller 474 for controlling each clamp of the CMC 20a (for instance, clamp controllers 474a-474k for clamps 50a-50k, respectively).

The board controller 470, head controller 472, and clamp controllers 474a-474k may each have a processor and memory (including software/firmware code), not shown separately. Moreover, the CMC 20a includes an input/output (I/O) 480 (optionally with a controller) for communicating with the ECU 430a. All of the components of the CMC 20a may communicate, directly or indirectly, with one another via one or more buses 482.

The board controller 470 receives input signals from the PC 408a via the ECU 430a and outputs one or more signals to the head controller 47 and clamp controllers 474a-474k for controlling the combined positioning system 22 and the clamps. The board controller 470, head controller 472, and clamp controllers 474a-474k may receive input signals from various sensors 482 on the CMC 20a. For instance, the head controller 472 may receive one or more output signals from the combined positioning system 22 indicative of the position or status of the cutter head. The clamp controllers 474a-474k may receive one or more output signals from the sensor assemblies 92 or 292 indicative of the clamp status (e.g., extended or retracted, mat engaging or mat disengaged). Any other CMC sensors may also be included.

It can be appreciated that the detected clamp position is dependent upon the positional accuracy of the first sensor element (such as a ring magnet) relative to the second sensor element. Prior calibration techniques involve manually positioning the external second sensor element relative to the internal first sensor element. The manual calibration process produces inconsistent readings, it is difficult to field correct, and it is susceptible to interference from electro-magnetic sources. Coupled with component tolerances, the manual calibration process makes the CMC unreliable.

An initial automated clamp calibration process may be carried out by a calibration module 478a-478k of the respective clamp controller 474a-474k to ensure that the clamp position is correctly detected by the clamp controller. In one example, the clamp calibration process may start by instructing the operator (through a graphical display on a computing device or otherwise) to place each clamp in a 6:00 position to allow the clamps to fully recess below the cutting surface. Once the clamp is energized, an analog output from the external sensor may be sampled a set number of times (e.g., 64 times) through an analog to digital converter to determine an average value. In at least the case of a magnet sensor assembly, the same procedure is followed in the 3:00 and 9:00 positions, which are needed to determine the correct polarity of the magnet and any imperfections within the magnet. These calibrated reference values are then stored in each of the clamp controllers 474a-474k and used as a baseline comparison to the sensed value to determine if the clamp is above or recessed below the cutting surface when energized. The above-described averaging technique accommodates varying tolerances and electro-magnetic interference of the CMC 20a.

The memory 450 or 462 of the PC 408a or ECU 430a, respectively (or any memory in the board controller 470, head controller 472, or clamp controllers 474) may include random access memory (RAM), read only memory (ROM), flash RAM, other types of memory, or some combination thereof. The memory may store computer-readable, computer-executable software/firmware code (such as S/W 452 and S/W 464) which may include instructions that, when executed, cause a processor to perform various functions described in this disclosure (e.g., receiving instructions for a mat design, defining a mat cutting or finishing path, configuring the clamps, etc.). Alternatively, the software/firmware code may not be directly executable by a processor but may cause a computer to perform functions described herein. Alternatively, the computer-readable, computer-executable software/firmware code may not be directly executable by the processor but may be configured to cause a computer (e.g., when compiled and executed) to perform functions described herein.

In some embodiments, the memory 450 or 462 (or any memory in the board controller 470, head controller 472, or clamp controllers 474) can contain, among other things, the Basic Input-Output system (BIOS) which may control basic hardware and/or software operation such as the interaction with peripheral components or devices. Applications may be resident within the PC 408a, e.g., a hard disk drive or other storage medium, alternatively or additionally, applications can be in the form of electronic signals modulated in accordance with the application and data communication technology when accessed via a network interface.

The processor 448 or 460 of the PC 408a or ECU 430a, respectively (or any processor in the board controller 470, head controller 472, or clamp controllers 474) may include an intelligent hardware device, e.g., a central processing unit (CPU), a microcontroller, an application-specific integrated circuit (ASIC), etc. A software module can include computer-readable programming code (in any language) which, when executed by a processor, causes the processor to perform certain operations, thus making a device operating with the processor as instructed by the module into a special purpose system or device.

The mat design module 440, mat cutting module 442, and clamp configuration module 444 of the PC 408a will now be described. The mat design module 502 may be used to design a pattern or finish in the matboard 44. For instance, the mat design module 502 may enable a user to select a mat size, orientation (e.g., landscape or portrait), shape (e.g., square, rectangular, oval, etc.), mat window configuration (e.g., size, shape, location, etc.), the type of cut (e.g., beveled, straight, V-groove, etc.), or a special design or finish (e.g., embossing, pen detailing, etc.) for the matboard 44.

Once the mat design parameters are configured through the mat design module 502, the mat cutting module 442 may be used to define a cutting and/or finishing path of the combined positioning system 22 of the CMC 20a for cutting a desired opening or decorative carving in the matboard 44 or otherwise applying a decorative finish to the matboard. The cutting and/or finishing path of the combined positioning system 22 may additionally or instead be dependent on the clamps 50 required to secure the matboard 44 to the mat table 24. The mat cutting module 442 directs the head controller 472 (through the ECU 408a) to move the cutter head of the combined positioning system 22 in and x-, y-, and z-direction to make the desired cuts or finishes on the matboard 44.

The clamp configuration module 444 may be used to determine which clamps 50 (e.g., some or all of clamps 50a-50k shown in FIG. 1) should be used to secure the matboard 44 to the mat table 24 without occluding the cutter head of the combined positioning system 22. For instance, when a customer wishes to maximize the yield on their matboard 44 by cutting multiple mats with “shared edges” or in “zero waste mode”, they will input mat design parameters to cut multiple mats from a single sheet of matboard (e.g., four 16″×20″ mats can be cut from a 32″×40″ sheet of matboard). To accomplish this, the cutter head must be able to cut to the edge of the matboard, and certain clamps holding the matboard to the table may be in the way of the cutter head. The clamp configuration module 444 identifies the clamps 50 that should and should not be used to secure the matboard 44 to the mat table 24 to accommodate the design path of the cutter head.

The clamp configuration module 444 may instruct the clamp controller 474 of a clamp to provide a first status indicator that indicates whether the clamp should be used. For instance, the clamp configuration module 444 may instruct the clamp controller 474 of a clamp to turn its LED green if that clamp should be used to secure the matboard 44 to the mat table 24 and red if that clamp that should not be used. Any clamp identified with a green LED light is moved into the mat engaging, retracted position to clamp down onto the matboard 44. Any clamp identified with a red LED light is moved into the mat disengaged, retracted position to recess below the cutting surface 46, thereby avoiding collisions with the cutter head.

The clamp configuration module 444 may also be used to instruct the clamp controller 474 to move the clamp into the correct position. For instance, if the clamp is in the mat engaging, retracted position and needs to be moved into the mat disengaged, retracted position, the clamp configuration module 444 can be used to instruct the processor 448 to output one or more signals to the clamp controller 474 to move the clamp into the mat disengaged, retracted position. More specifically, the clamp controller 474 is instructed to activate the pressurized air source to move the piston assembly of the clamp into the extended position, to activate the actuator assembly to turn the clamp into the mat disengaged position (or allow for manual turning of the clamp), and then to activate the pressurized air source to move the piston assembly of the clamp into the retracted position.

Similarly, if the clamp is in the mat disengaged, retracted position and needs to be moved into the mat engaging, retracted position, the clamp configuration module 444 can be used to instruct the processor 448 to output one or more signals to the clamp controller 474 to move the clamp into the mat engaging, retracted position. More specifically, the clamp controller 474 is instructed to activate the pressurized air source to move the piston assembly of the clamp into the extended position, to activate the actuator assembly to turn the clamp into the mat engaging position (or allow for manual turning of the clamp), and then to activate the pressurized air source to move the piston assembly of the clamp into the retracted position.

The clamp configuration module 444 may also be used to determine the status or position of all the clamps before the mat cutting module 442 directs the combined positioning system 22 of the CMC 20a to cut or apply a finish to the matboard. For instance, when the mat cutting module 442 directs the head controller 472 to cut/finish the matboard, the clamp configuration module 444 will first poll the board controller 470 (which polls each clamp controller 474) to determine the status of all the clamps. If any of the clamps are in the incorrect position, the clamp configuration module 444 may instruct the clamp controller 474 of that clamp to provide a second status indicator. For instance, if a clamp is in the incorrect position, the LED of that clamp can flash, change color, etc., and in some instances, the combined positioning system 22 can be prevented from cutting/finishing the matboard.

In one non-limiting example, if the clamp is in a mat engaging, retracted position and it should be in a mat disengaged, retracted position, the LED for that clamp will flash red and the head controller 472 will prevent the CMC 20 from cutting/finishing the matboard. Rather, the clamp must first be moved into a mat disengaged, retracted position to avoid collision with the cutter head. If the clamp is in a mat disengaged, retracted position, and it should be in a mat engaging, retracted position, the LED for that clamp will flash green. The clamp configuration module 444 can optionally instruct the head controller 472 to allow the cutting/finishing of the matboard with the user's acknowledgement that not all the recommended clamps are being used to secure the matboard.

Corrective actions can be taken automatically by the PC 408a and/or manually by the user to correct the clamp position as described above. Moreover, if a clamp is in the correct position, the clamp configuration module 444 may instruct the clamp controller 474 of that clamp to provide a third status indicator. For instance, if a clamp is in the correct position, the LED of that clamp may remain a solid color, either red (e.g., for the mat disengaged, retracted position) or green (e.g., for the mat engaging, retracted position). Any other status indicators or LED arrangement may instead be used to indicate the status or position of the clamps.

In one embodiment, an emergency stop button (not shown) may be used to immediately halt operation of the CMC 20a (e.g., movement of the cutter head). More specifically, the emergency stop button may output a signal(s) to the ECU 430a (optionally first to the PC 408a), which outputs a signal(s) to the head controller 472 to immediately halt the motor(s) of the cutter head. When the emergency stop button is engaged, the clamp configuration module 444 may instruct the clamp controllers 474 to provide a fourth status indicator. For instance, all clamp LEDs may immediately flash red until the emergency stop button is disengaged. Once the emergency stop button is disengaged, it can output a signal(s) to the ECU 430a, which can output a signal(s) to the head controller 472 to reactivate the motor(s) of the cutter head. The clamp configuration module 444 may also instruct the clamp controllers 474 to turn the LED back to a solid color.

The CMC system 400 improves over prior art mat cutting systems, which employ a fully manual operation. More specifically, prior art mat cutting systems rely on the operator to make the correct clamp adjustments without feedback indicating whether the clamp adjustment was made correctly. As can be appreciated from the foregoing, an initial automated clamp calibration process may be used to ensure that the clamp position is correctly detected by the clamp controllers 474a-474k for accurate reporting to and processing by the clamp configuration module 444. The clamp configuration module 444 also allows a user to automatically determine the correct position of the clamp and whether the clamp needs to be moved into a different position. The clamp configuration module 444 can also be used to partially or fully automate movement of the clamp into the correct position. Further, the clamp configuration module 444 can verify that the clamp has been moved into the correct position and enable activation of the cutter head when clamp collision avoidance is clear.

In some embodiments, all of the elements shown in FIG. 11 need not be present to practice the present systems and methods. The devices and subsystems can be interconnected in different ways from that shown in FIG. 11. In some embodiments, an aspect of some operation of a system, such as that shown in FIG. 11, may be readily known in the art and are not discussed in detail in this application. Code to implement the present disclosure can be stored in a non-transitory computer-readable medium such as one or more of memory 450 or 464 of the PC 408a or ECU 430a, respectively (or any memory in the board controller 470, head controller 472, or clamp controllers 474) or other memory.

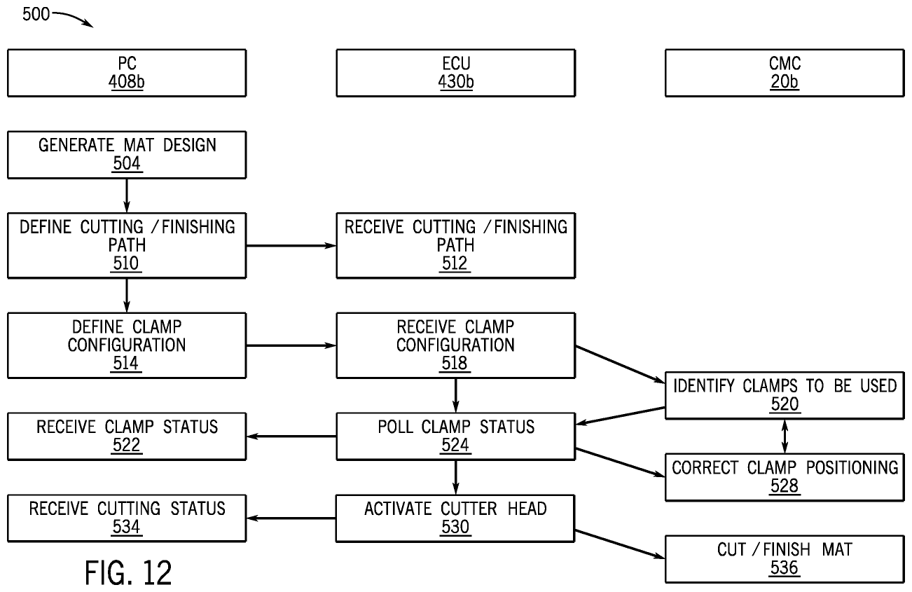

FIG. 12 is a swim diagram 500 illustrating the various ways a PC, ECU, and CMC can interact. The swim diagram 500 includes a PC 408b, an ECU 430b, and a CMC 20b, which may be examples of the computing device 408 or 408a, ECU 430 or 430a, and CMC 20 or 20a referenced above with respect to FIGS. 1, 10, or 11. In that regard, identical reference numerals are used except in the “b” series. Moreover, other components described herein may also be included. Further, the steps identified for each of the components may instead be carried out on any other component. For instance, any instructions sent from the ECU 430b to the CMC 20b may originate from the PC 408b. Moreover, any instructions sent from the PC 408b to the ECU 430b, and then to the CMC 20b may instead be sent directly from the PC 408b to the CMC 20b. Moreover, it should be appreciated that the functionally of the PC 408b and the ECU 430b may be incorporated into the CMC 20b.

At block 504, the PC 408b may generate a mat design with the mat design module 440. Once the mat design parameters are configured in block 504, the mat cutting module 442 may be used to define a cutting and/or finishing path for the cutter head of the CMC 20b, as indicated by block 510. After the cutting/finishing path is defined at block 510, the PC 408b may output one or more signals to the ECU 430b, which receives the cutting/finishing path at block 512.

At block 514, the clamp configuration module 444 may then be used to determine which clamps 50 should be used to secure the mat board 44 to the mat table 24 without occluding the cutter head of the CMC 20b. The clamp configuration may depend on the chosen mat design, whether the mat design uses shared edges, etc.

After the clamp configuration is defined at blocked 514, the PC 408b may output one or more signals to the ECU 430b, which receives the clamp configuration at block 518. Upon receiving the clamp configuration, the ECU 430b can instruct the clamp controller of each clamp to provide a first status indicator for the clamp depending on whether it should be used to secure the mat board 44 to the mat table 24 at block 520. For instance, the ECU 430b can instruct the clamp controller of each clamp to turn the LED green for a clamp that should be used and red for a clamp that should not be used.

Either before or after the ECU 430b instructs the clamp controller to provide a first status indicator, at block 524, the ECU 430b can poll each of the clamps to get a status of that clamp (e.g., whether the clamp is in an extended position, retracted position, mat engaging position, and/or a mat disengaged position). Depending on whether the clamp position is identified as a position that is correct for the mat cutting/finishing process, at block 520, the ECU 430b may instruct the clamp controller of each clamp to provide a second status indicator for the clamp to indicate which clamps should be used.

For instance, if the clamp is in a mat engaging, retracted position and it should be in a mat disengaged, retracted position, the LED for that clamp may flash red and the head controller 472 will prevent the CMC 20 from cutting/finishing the matboard. Rather, the clamp must first be moved into a mat disengaged, retracted position to avoid collision with the cutter head. If the clamp is in a mat disengaged, retracted position, and it should be in a mat engaging, retracted position, the LED for that clamp may flash green. The status of the clamps is continuously sent to the PC 408b, as indicated at block 522, which may output one or more instructions to the ECU 430b for controlling the clamps.

If the clamp position needs to be corrected, the ECU 430b may instruct the clamp controller of each clamp to move the clamp into the correct position for the cutting/finishing process, as indicated at block 528. For instance, any clamp identified with a green flashing LED light is moved into the mat engaging, retracted position to clamp down onto the matboard 44. Any clamp identified with a red flashing LED light is moved into the mat disengaged, retracted position to recess below the cutting surface 46, thereby avoiding collisions with the cutter head.

The ECU 430b may then again poll each of the clamps to get a status of that clamp at block 524 (e.g., whether the clamp is in an extended position, retracted position, mat engaging position, and/or a mat disengaged position). Depending on whether the clamp position is identified as a position that is correct for the mat cutting/finishing process, the ECU 430b may instruct the clamp controller of each clamp to provide a status indicator for the clamp at block 520. All clamps that are correctly in the mat engaging, retracted position may have a solid green LED, and all clamps that are correctly in the mat disengaged, retracted position may have a solid red LED. Any incorrectly positioned clamps may be identified with a red or green flashing LED light, as described above, and moved into the correct position, as indicated at block 528. In lieu of or in addition to the second poll of the clamp status at block 524, the PC 408b and/or the ECU 430b may run a clamp interference check to determine if any clamps are in the path of the cutter head, and provide a status indicator (e.g., a red flashing LED) for any of those clamps.

If all the clamps are in the correct position, the ECU 430b may activate the cutter head to begin the mat cutting/finishing process at block 530 and provide a status to the PC 408b at block 534. Either before or after the ECU 430b activates the cutter head at block 530, the ECU 430b may send the cutting/finishing path instructions (received at block 512) to the cutter head. The CMC 20b then cuts/finishes the mat at block 536.

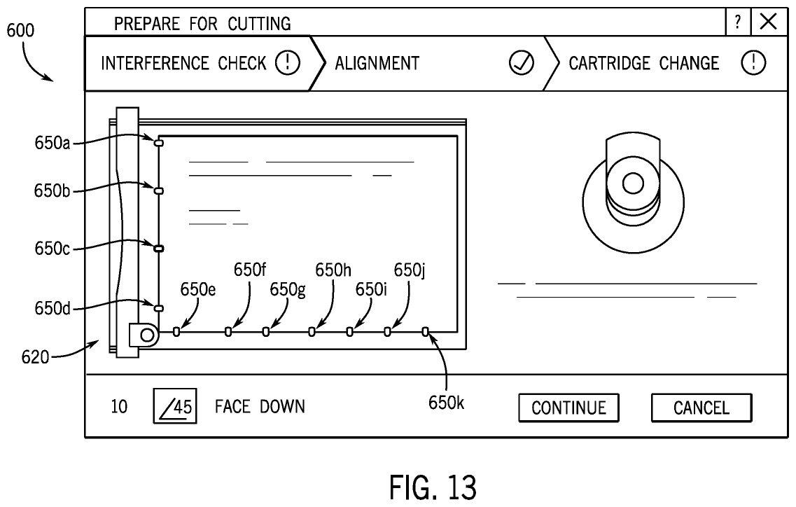

FIG. 13 depicts an exemplary screen shot of a graphical user interface (GUI) 600 used to display a clamp interference check for a CMC (such as CMC 20, 20a, or 20b). A user can run an interference check before proceeding with the cutting/finishing process, and the interference results may be displayed on the GUI 600. The GUI 600 may be associated with the user interface module 446 on the PC 408a and may be displayed on a display device associated with the PC 408a.

In the exemplary screenshot shown, the GUI 600 shows a graphical depiction of a CMC 620 having clamps 620a-620k. As a result of the interference check, clamp 650c includes a flashing red LED indicator (not shown in color in the FIGURE) indicating that clamp 650c should be in the mat disengaged position (i.e., it is in the path of the cutter head). The results displayed on the GUI 600 may correspond to the actual LED indicators illuminated on the CMC. For instance, and referring to FIG. 1, clamp 50c may be flashing red on the CMC 20 to indicate that it should be moved to the mat disengaged position.

The user interface module 446 may be used to display any other GUI on a display device associated with the PC 408a indicative of the status of the CMC. For instance, the GUI may display results of the clamp configuration module 444 after it identifies the clamps that should and should not be used to secure the matboard to the mat table to accommodate the design path of the cutter head (e.g., green status indicator for clamps that should be used and red status indicator for clamps that should not be used). Any other GUI may be used to interface with the CMC.

### Clamp Controller Bus Structure

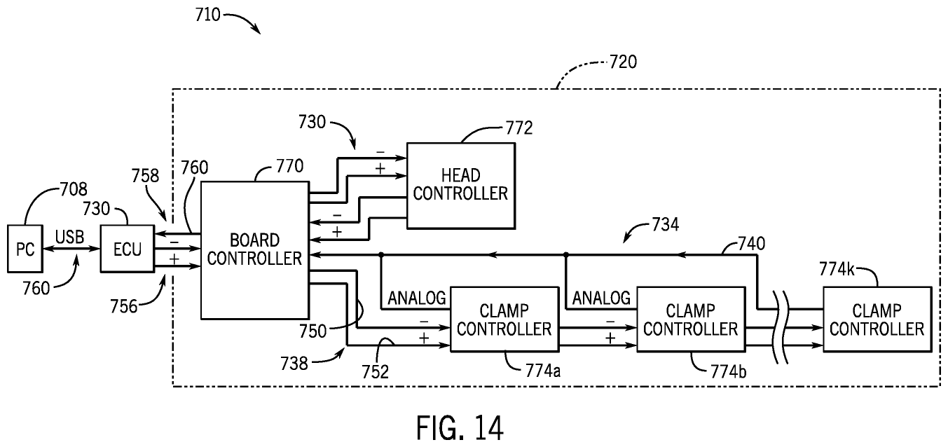

FIG. 14 shows a graphical depiction of an exemplary structure for a CMC bus 710 of a CMC 720, which may be substantially identical to CMC 20, 20a, or 20b described herein.

In that regard, identical reference numerals are used except in the “700” series.

The CMC bus 710 enables communications between components of the CMC 720, such as a board controller 770, a head controller 772, and clamp controllers 774a-774k. The board controller 770, head controller 772, and clamp controllers 774a-774k may be examples of the board controller 470, head controller 472, and clamp controllers 474a-474k of FIG. 11. To that end, the CMC bus 710 may be an example of the bus 484 of CMC 20a.

In a CMC such as those described herein, the signal integrity of the bus(es) can be compromised by noise emitted from other components in close proximity to signal producing components on the bus (i.e., the head controller 472 and clamp controllers 474a-474k) or the bus lines. For instance, motors in the combined positioning system, such as one or more cutter head motors, a gantry motor, etc. (not shown), are in close proximity to the clamp controllers. The motors radiate and emit electromagnetic noise that couples to the bus and compromises integrity of the clamp controller signals.

Although shielding around the motors or signal processing filters can help reduce radiated noise, the inventors found that shielding and filters did not sufficiently reduce the noise induced into the bus. Moreover, moving the motors out of the cutter head would compromise the cutting and finishing ability of the cutter head. Further, eliminating the clamp sensors and controllers, as in prior art machines, would compromise the ability to control the clamping process and minimize cutter head occlusion.

The CMC bus 710 of the present disclosure is designed to increase noise immunity for data communications of a CMC having motors or other noise-emitting components in close proximity to the bus and its components (i.e., the head controller and/or the clamp controllers 774a-774k). In a first aspect, the CMC bus 710 includes a head controller bus 732 that communicatively couples the board controller 770 to the head controller 772. In a second aspect, the CMC bus 710 includes clamp controller bus 734 that communicatively couples the board controller 770 to the clamp controllers 774a-774k.

The head controller bus 732 for communicatively coupling the board controller 770 to the head controller 772 will first be described. The head controller bus 732 is generally configured as a dual ended serial differential bus that allows bi-directional communications simultaneously between the board controller 770 and the head controller 772 for controlling the combined positioning system (e.g., the cutter head) of the CMC 720a. The dual ended transmitters and receivers provide protection against unwanted noise caused by electro-magnetic interference from the motors, as well as switching power supplies and pulse width modulation (PWM) drivers. The dual ended transmitters and receivers defined by the head controller bus 732 also provide good noise immunity over the longer distances of the bus.

The clamp controller bus 734 for communicatively coupling the board controller 770 to the clamp controllers 774a-774k will now be described. The clamp controller bus 734 includes a first bus 738 that transmits signals from the board controller 770 to the clamp controllers 774a-774k. The first bus 738 is a dual ended serial differential bus that allows transmit signals to flow in the downstream direction from the board controller 770 to the clamp controllers 774a-774k. When configured as a dual ended serial differential bus, the first bus 738 provides greater noise immunity than a single ended bus. More specifically, the first bus 738 includes first and second signal lines 750 and 752 that create a voltage level differential therebetween to reduce the noise.

The first bus 738 also provide good noise immunity over longer distances of the bus. As can be seen in FIG. 14, the first bus 738 couples the clamp controllers 774a-774k in series. By using a dual ended serial differential bus, the signal is not compromised as it travels toward the clamp controllers at the end of the bus (such as clamp controllers 774j and 774k).

Response signals flow in the upstream direction from each clamp controller 774a-774k to the board controller 770 through a second bus 740. The second bus 740 is an analog bus line that is read by an analog to digital converter (ADC) of the board controller 770.

The analog voltage response signals from each clamp controller 774a-774k represent the current position of the clamp. As described above with reference to FIGS. 4-9, each clamp includes a sensor assembly that is used to determine the position of the clamp (e.g., extended, retracted, mat engaging, and/or disengaged). The sensor assembly outputs one or more signals to its respective clamp controller that is indicative of the clamp position. The controller then outputs an analog voltage response signal representing the current position of the clamp.

For instance, if any of the clamp controllers 774a-774k respond with a “high level voltage” signal (e.g., around 5V), the clamp was detected in the disengaged retracted (recessed) position (i.e., below the cutting surface). If a “low level voltage” is detected (e.g., around 0V), the clamp is currently in an extended position protruding above the cutting surface. Response signals may be held at a “mid-level voltage” signal, indicating the clamp is in an idle state (e.g., in neither the extended nor retracted position), for instance, during the initialization process. Additional signals may be outputted on the same or an additional bus indicative of whether the clamp is in the mat engaging or disengaged position.

In the exemplary embodiment, the second bus 740 is an analog bus line rather than a digital bus line to increase noise immunity in the response signals. A digital signal is more susceptible to noise because of the lower trip point (there is a low threshold between the 1 and 0 signal) compared to an analog signal using a sufficient voltage differential, such as 0 to 5V. Accordingly, the analog second bus 740 further increases noise immunity in the clamp controller bus 734.

To simply wiring on the clamp controller bus 734, however, the analog second bus 740 is a single ended bus structure. In that regard, each clamp controller 774a-774k is networked together on the single analog second bus 740, with response signals flowing in the upstream direction. To prevent the clamp controllers 774a-774k from communicating at the same time, each clamp controller 774a-774k contains a unique address, and it will only occupy the analog second bus 740 when addressed by the board controller 770. Unique addressing of the clamp controllers 774a-774k prevents multiple clamp controllers from communicating with the board controller 770 at the same time, which would cause bus contention and invalid data.

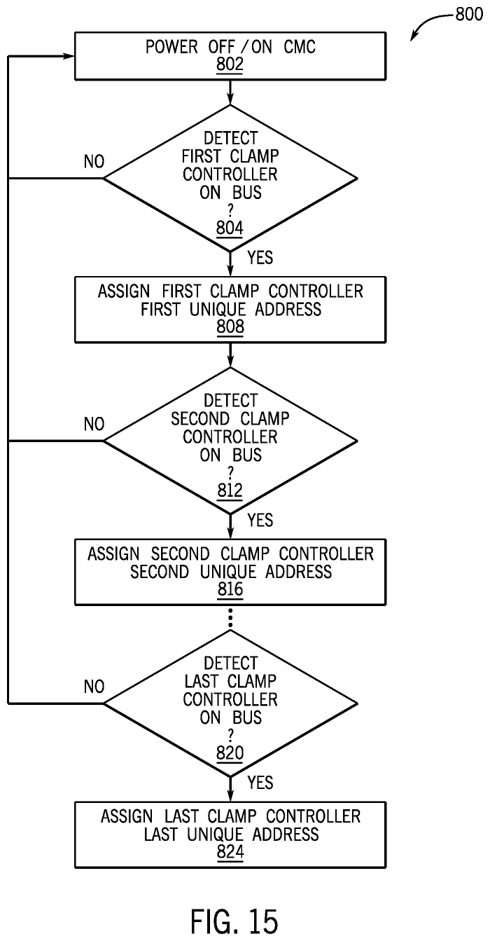

FIG. 15 illustrates an exemplary method 800 of creating a unique address for each clamp controllers 774a-774k. An initialization process begins at block 802, where the CMC 720 is and powered on (after optionally being powered off). At decision block 804, the board controller 770 tries to communicate with a first clamp controller on the clamp controller bus 734, such as clamp controller 774a. If a first clamp controller is detected, the board controller 770 assigns it a first unique address at block 808. If no first clamp controller is detected, the CMC 720 is powered off and then back on at block 802.

Once the first clamp controller 774a is programmed with its unique first address, the board controller 770 opens communications to the next downstream clamp controller at decision block 812. If the board controller 770 detects a second clamp controller on the bus 734, such as clamp controller 774b, the board controller assigns it a second unique address at block 816. If no second clamp controller is detected, the CMC 720 is powered off and then back on at block 802.

The board controller 770 continues to sequentially assign unique addresses at blocks 820 and 824 for each of the clamp controllers 774a-774k on the bus 734 until all of the clamp controllers have been programmed with their own unique address. If one of the downstream clamp controllers 774a-774k is not communicating properly and will not accept a unique address, the initialization process stops and the remaining downstream clamp controllers will not be programmed and will not function properly. In this instance, the CMC can be powered down and back up again at block 802 to start the addressing process again.

The unique address is stored in volatile memory of the clamp controllers 774a-774k. Therefore, the unique addresses are erased if power is removed from the CMC 720. However, each clamp controller 774a-774k is reassigned a unique and sequential address by the board controller 770 each time power is reapplied at block 802.

Once each controller has a unique address, the board controller 770 can broadcast commands to all the clamp controllers 774a-774k simultaneously, such as commands to poll clamp status, change clamp position, etc. However, the board controller 770 only receives data from a specific clamp controller when addressed. In other words, a clamp controller can only transmit signals on the analog second bus 740 if it is addressed by the board controller 770. This single ended bus structure allows for unique addressing of clamp controllers, regardless of how many clamp controllers are installed on a particular CMC configuration.

The board controller 770 also communicates with an ECU 730 via an ECU bus 756. The ECU 730 may be an example of the ECU 430 or 430a of FIGS. 10 and 11. To that end, the ECU bus 756 may be an example of the bus 468 of ECU 430a.

In the exemplary embodiment, the ECU bus 756 includes a first bus line 758 that allows the ECU 730 to send commands to the downstream board controller 770. The first bus line 758 is configured as a dual ended differential serial bus, which allows communications over longer distances and provided better noise immunity, as described above with respect to the first bus 738 of the clamp controller bus 734.

Upstream responses from the board controller 770 back to the ECU 730 are sent across a second bus line 760. The second bus line 760 may be configured as a single ended serial bus as shown to accommodate the external I/O structure of the ECU 730. However, to increase noise immunity over a single wire bus, check summing of the data may be implemented, which verifies the validity of the data using a mathematical algorithm of bit counting. The full duplex configuration of the ECU bus 756 allows bi-directional data transfers simultaneously. It should be appreciated, however, that the second bus line 758 of the ECU bus 756 may instead be configured as a dual ended differential serial bus to improve noise immunity.

The ECU 730 is generally configured to receive, process, and send data between a PC 708 and the CMC 720. More specifically, the ECU 730 is in communication with the PC 708 to receive PC commands for controlling the CMC 720 and for sending CMC status updates to the PC.

The ECU 730 communicates with the PC 708 via a PC bus 760. The PC 708 may be an example of the PC 408 or 408a of FIGS. 10 and 11. To that end, the PC bus 760 may be an example of the bus 456 of PC 408a. In the exemplary embodiment, the PC bus 760 is defined by a standard Universal Serial Bus (USB) cable connected to the I/O ports of the ECU 730 and PC 708. However, any other suitable communicative coupling may instead be used.

The PC bus 760 communicates all status information and commands between its software applications (e.g., the mat design module 440, mat cutting module 442, clamp configuration module 444, and user interface module 446) and the various controllers of the CMC 720 (e.g., the board controller 770, head controller 772, and clamp controllers 774a-774k). When a status request is sent from the PC 720 to a particular CMC controller, the CMC controller may respond with a data string that contains several status indicators, including sensor states, buffer status, positional data, etc. In normal operation, the CMC is continuously returning its status to the software applications of the PC 708, even when the CMC 720 is in an idle state.

### Computing Device Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

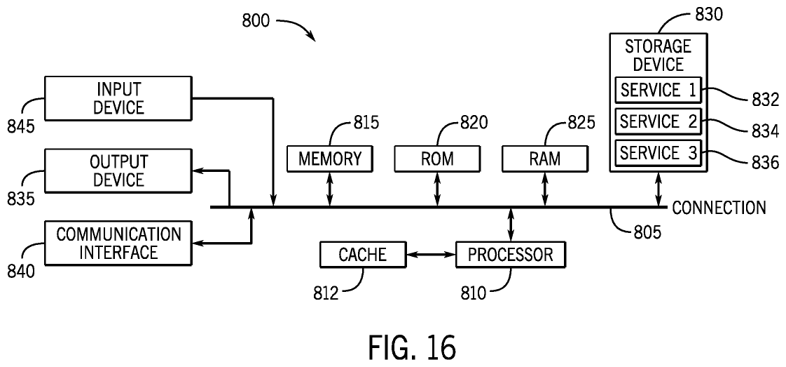

FIG. 16 is a diagram illustrating an example of a system for implementing certain aspects of the present technology. In particular, FIG. 16 illustrates an example of computing system 800, which can be for example any computing device making up internal computing system, a remote computing system, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface 840 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

In some implementations, the communication interface 840 can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown).

The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a swim diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an exemplary embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “extended”, “retracted”, “tilted”, “non-tilted”, “top”, “bottom”, “vertical”, “horizontal”, “lateral”, etc., in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only, and are not to be taken as limiting the disclosure in any way.

While preferred embodiments of the present invention have been shown and described herein, it will be apparent to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-15. (canceled)

16. A computerized mat cutter machine system, comprising:
a mat table having a cutter surface;
at least one clamp moveable between a clamped position to secure a matboard to the mat table and a non-clamped position;
a cutter head for performing at least one of cutting and finishing a design in the matboard; and
a clamp controller bus for communicatively coupling a board controller to a clamp controller of the at least one clamp, the clamp controller bus comprising:
a first bus configured as a dual ended serial differential bus that allows signals to flow from the board controller to the clamp controller; and
a second bus configured as an analog bus that allows signals to flow from the clamp controller to the board controller.

17. The system of claim 16, further comprising one or more processors configured to interact with non-transitory memory to perform operations comprising:
generating a mat design;
defining at least one of a cutting and finishing path for the mat design;
defining a clamp configuration for the at least one clamp that is configured to secure the matboard to a mat table;
providing a first status indicator if the at least one clamp should be moved into a clamped position to secure the matboard to the mat table and a second status indicator if the at least one clamp should be moved into a non-clamped position; and
activating the cutter head.

18. The system of claim 17, further comprising a status indicator assembly configured to indicate whether the at least one clamp is in the clamped position or the non-clamped position.

19-21. (canceled)

22. The system of claim 17, further comprising a piston assembly configured to move the at least one clamp between the clamped position and the non-clamped position.

23-24. (canceled)

25. The system of claim 17, further comprising an actuator assembly configured to move the at least one clamp between a mat-engaging position and a mat disengaged position.

26. The system of claim 25, wherein the at least one clamp is configured to be moved into the clamped position in the mat-engaging position and the at least one clamp is configured to be moved into the non-clamped position in the mat disengaged position.

27. The system of claim 17, further comprising a sensor assembly for sensing whether the at least one clamp is in the clamped position or the non-clamped position.

28. The system of claim 16, wherein the first bus includes first and second signal lines that create a voltage level differential therebetween.

29. (canceled)

30. The system of claim 16, wherein the second bus is a single ended bus structure, and wherein a plurality of clamp controllers are networked together on the second bus with signals flowing from the clamp controllers to the board controller.

31. The system of claim 30, wherein each clamp controller contains a unique address that will occupy the second bus only when addressed by the board controller.

32. The system of claim 16, wherein the clamp controller outputs an analog voltage signal representing a clamped or non-clamped position of the clamp.

33-35. (canceled)

36. A computerized mat cutter machine system, comprising:
a mat table having a cutter surface;
a cutter head for performing at least one of cutting and finishing a design in a matboard;
at least one clamp moveable between a clamped position to secure a matboard to the mat table and a non-clamped position, wherein the at least one clamp comprises:
a piston assembly configured to move the at least one clamp between the clamped position and the non-clamped position;
a sensor assembly for sensing whether the at least one clamp is in the clamped position or the non-clamped position; and
an actuator assembly configured to move the at least one clamp between a mat-engaging position and a mat disengaged position.

37. The system of claim 36, further comprising a status indicator assembly configured to indicate whether the at least one clamp is in the clamped position or the non-clamped position.

38-40. (canceled)

41. The system of claim 36, wherein the sensor assembly includes a magnet secured to the piston assembly that is sensed by a sensor when the piston assembly is moved into at least one of an extended position and a retracted position.

42. The system of claim 36, wherein the at least one clamp is configured to be moved into the clamped position in the mat-engaging position and the at least one clamp is configured to be moved into the non-clamped position in the mat disengaged position.

43. The system of claim 36, further comprising a clamp controller bus for communicatively coupling a board controller to a clamp controller of the at least one clamp, the clamp controller bus comprising:
a first bus configured as a dual ended serial differential bus that allows signals to flow from the board controller to the clamp controller; and
a second bus configured as an analog bus that allows signals to flow from the clamp controller to the board controller.

44-51. (canceled)

52. A clamp for a computerized mat cutter machine system having a mat table defining a cutter surface, the clamp comprising:
a piston assembly moveable between an extended position and a retracted position;
a clamped portion defined at a first end of the piston assembly;
a sensor assembly for sensing whether the piston assembly is in the extended position or the retracted position; and
an actuator assembly configured to move the piston assembly between a mat-engaging position, wherein the clamped portion is configured to be moved into a clamped position, and a mat disengaged position, wherein the clamped portion is configured to be moved into a non-clamped position.

53-58. (canceled)

59. The clamp of claim 52, wherein the sensor assembly includes a magnet moveable with the piston assembly that is sensed by a sensor when the piston assembly is moved into at least one of the extended position and the retracted position.

60. The clamp of claim 52, wherein the piston assembly is configured to be moved into a first retracted position to move the clamped portion into the clamped position and the piston assembly is configured to be moved into a second retracted position to move the clamped portion into the non-clamped position.

61. (canceled)

62. The clamp of claim 52, wherein the actuator assembly includes a motor having an output shaft, wherein the piston assembly is coupled to a drive shaft such that rotation of the drive shaft causes corresponding rotation of the piston assembly and such that the piston assembly can move vertically relative to the drive shaft to accommodate movement of the piston assembly between the extended and retracted positions.
